(19) United States
(12) Patent Application Publication
(10) Pub. No.: US 2022/0312796 A1
(43) Pub. Date: Oct. 6, 2022

(54) JUICY SPONGE FOOD PRODUCT

(71) Applicant: SOCIETE DES PRODUITS NESTLE S.A., Vevey (CH)

(72) Inventors: MARTIN LESER, Bretigny-sur-Morrens (CH); MARTIN MICHEL, Lausanne (CH); ERIC JOSEF WINDHAB, Hemishofen (CH); SOCRATES FOSCHINI, Zurich (CH); JUDITH WEMMER, Zurich (CH); LOREDANA MALAFRONTE, Zurich (CH)

(21) Appl. No.: 17/753,323

(22) PCT Filed: Aug. 28, 2020
(86) PCT No.: PCT/EP2020/074089

§ 371 Date: Feb. 28, 2022

(30) Foreign Application Priority Data
Aug. 30, 2019 (EP) 19194739.9

(51) Int. Cl. A23J 3/26; A23P 30/40; A23J 3/08; A23L 7/109; A23J 3/16; A23L 2/02

(52) U.S. Cl. CPC A23J 3/26; A23P 30/40; A23J 3/08; A23L 7/109; A23J 3/16; A23L 2/02; A23V 2002/00

(57) ABSTRACT

The present invention relates to a method of making a porous edible formulation that can absorb water and oil. Methods of preparing said formulation and its use in food products are also provided.

### BACKGROUND

Many fruits and vegetables are juicy as well as crunchy. These physical properties are linked to the fact that vegetable and fruit tissues are mostly made up of polyhedral parenchyma cells with thin cell walls held together by a middle Iamella (Niklas, 1992). Their structure can be considered as densely packed, liquid-filled closed-cell foams. The mechanical properties of the tissue depend on the mechanics of cell wall and middle Iamella as well as on the internal pressure of the plant cell, referred to as turgor. Hence, the application of stress during biting results in brittle fracturing of the cell wall surrounding the liquid-filled membrane. This can be seen, for example, in fresh carrot tissue. The break-up leads to the release of cytosol and thereby to the perception of juiciness. Cooking, ripening or enzymatic degradation decreases the stability of the pectinaceous middle Iamella leading to the softening of the structure. As a consequence the cytosol is not released anymore upon biting. This leads to a dry or “mealy” perception independent of the water content (Lillford, 2011).

Juiciness therefore relates to the amount of liquid released during mastication. It is also thought to be related to excretion of saliva. It is regarded as the ability to hold watery liquids and the ability to instantaneously release liquid upon exceeding a stress limit. The creation of new products which generate juicy perception would therefore be highly desirable for the food industry and the consumer alike.

### SUMMARY OF THE INVENTION

The invention relates in general to a method of making a porous edible formulation that can absorb water and oil, said method comprising the steps:
Preparing a protein dispersion in water;
Dispersing gas in the protein dispersion to form a foam structure;
Optionally moulding or shaping the foam structure;
Expansion of the foam structure;
Volumetric heating;
Optionally drying; and
Optionally cutting into pieces.

The invention further relates to a porous edible formulation comprising protein, preferably obtained by a method as described herein.

The invention further relates to the use of a porous edible formulation as described herein in a food product.

### EMBODIMENTS OF THE INVENTION

The present invention relates to a method of making a porous edible formulation that can absorb water and oil, said method comprising the steps:
Preparing a 5-60 wt % protein dispersion in aqueous liquid, preferably in water;
Dispersing gas in the protein dispersion to form a foam structure;
Optionally moulding or shaping the foam structure;
Expansion of the foam structure;
Volumetric heating induced water evaporation and protein denaturation;
Optionally drying; and
Optionally cutting into pieces
   wherein volumetric heating and/or drying comprises the application of electromagnetic waves.

In some embodiments, 10-50 wt % protein dispersion is prepared in aqueous liquid, preferably 15-45 wt % protein dispersion is prepared in aqueous liquid.

In some embodiments, the aqueous liquid is water.

In some embodiments, the protein dispersion is a globular protein dispersion.

In some embodiments, the protein dispersion is a homogenous dispersion.

In some embodiments, the protein dispersion is a non-plant protein dispersion, for example a whey protein isolate dispersion. In some embodiments, a 25-45 wt % whey protein isolate dispersion is prepared in water, preferably a 30-40 wt % whey protein isolate dispersion is prepared in water.

In some embodiments, the protein dispersion is a plant protein, for example pea protein, faba bean protein, canola protein, and soy bean protein, preferably pea protein. In some embodiments, a 10-20 wt % pea protein isolate dispersion is prepared in water.

In some embodiments, the protein dispersion further comprises fibre, for example citrus fibre, fibrillated cellulose, and/or pectin.

In some embodiments, the protein dispersion further comprises plasticisers for example sugar, and/or hydrocolloid.

In some embodiments, the protein dispersion is substantially devoid of starch.

In some embodiments, the protein dispersion is substantially devoid of oil.

In some embodiments, gas is dispersed in the protein dispersion using a mechanical device to form a foam structure, for example a rotating membrane foaming device to form a foam structure. The mechanical device may alternatively be a Kitchen Aid.

In some embodiments, the wet foam structure has a gas volume fraction of 10-90 vol %, preferably 40-80 vol %, most preferably 60-75 vol %.

In some embodiments, the bubble size has a D50 of less than 100 microns, preferably less than 70 microns, particularly when measured after foaming but before heating and drying.

In some embodiments, the foam structure is increased to above the protein denaturation temperature.

In some embodiments, volumetric heating results in a relative temperature gradient between the core and the surface layer of the foam structure wherein the relative temperature gradient defined as (Tcenter−Tsurface)/Tcenter is between −0.1 and 0.3, preferably between −0.1 and 0.2, more preferably between −0.1 and 0.1.

In some embodiments, the foam structure temperature has an average temperature greater than the denaturation temperature of the protein during heating.

In some embodiments, the electromagnetic waves are applied by microwave heating, most preferably microwave heating with superposition of convection heating.

In some embodiments, a vacuum is applied before and/or during drying which is between 10-800 mbar, preferably 50-500 mbar, more preferably between 100-300 mbar.

In some embodiments, said edible formulation has open pores having an average pore size of up to 500 microns, preferably up to 200 microns.

The invention further relates to a porous edible formulation that can absorb water and oil and comprises protein, obtained by a method as described herein.

In some embodiments, the edible formulation comprises protein and is substantially devoid of other solid matter.

The invention further relates to a porous edible formulation that can absorb water and oil and comprises 10-50 wt % protein, wherein the edible formulation has a water content <60 wt % and has a porosity of between 10-95 vol %, preferably 65-95 vol %, more preferably 80-95 vol %.

In some embodiments, said formulation can absorb water and oil without disintegrating to an extent of no greater than 10 wt %.

In some embodiments, said formulation can absorb water and oil without dissolving to an extent of no greater than 10 wt %. In other words, less than 10 % of the formulation dissolves or migrates to the liquid phase.

In some embodiments, the moisture content of the formulation is less than 20 wt %, preferably less than 10 wt %, more preferably less than 5 wt %.

In some embodiments, said formulation further comprises citrus fibre and/or polysaccharides.

In some embodiments, said formulation is capable of absorbing water and oil at substantially the same velocity, preferably wherein said velocity is greater than 1 mm/s.

In some embodiments, said formulation is capable of absorbing water and oil at substantially the same velocity, preferably wherein said velocity is up to 5 mm/s.

In some embodiments, the absorbed water and oil can be removed by compression or suction and re-absorbed into the same edible formulation.

In some embodiments, said formulation is capable of absorbing water at a velocity of up to 2.2 mm/s, preferably up to 5 mm/s at 0-100° C. and without structure disintegration.

In some embodiments, said formulation is capable of absorbing water with a temperature of 0-100° C., wherein up to 140 %, preferably up to 160 %, of pore volume is filled with water due to additional structural swelling effects.

In some embodiments, said formulation is capable of absorbing oil at a velocity of up to 1.5 mm/s, preferably up to 5 mm/s at 0-200° C. without disintegration of the formulation.

In some embodiments, said formulation is capable of absorbing oil with a temperature of 0-200° C., wherein up to 90% of pore volume, preferably up to 95% of pore volume, most preferably up to 100% of pore volume, is filled with oil.

In some embodiments, said formulation is elastically and/or plastically deformable after absorption of water and is brittle in substantially dry state after absorption of oil.

The invention further relates to use of a porous edible formulation as described herein in a food product, for example pasta.

The invention further relates to a food product comprising the porous edible formulation as described herein.

### BRIEF DESCRIPTION OF FIGURES

FIG. 1: Pictures of (A) whey protein isolate foam dried with hot air only (100° C., 3 h), (B) whey protein isolate sponge-structure dried with controlled microwave-hot air drying at 50 W/60° C., 3 h, and (C) whey protein isolate sponge-structure dried with controlled microwave-hot air drying at 100 W/60° C., 2 h.

FIG. 2: Relative temperature gradient inside the foam structure as a function of heating/drying time at different heating conditions.

FIG. 3: Scanning electron microscopy images of (A) whey protein isolate foam dried with hot air only (100° C., 3 h), (B) whey protein isolate sponge-structure dried with controlled microwave-hot air drying (50W/60° C., 3 h).

FIG. 4: Sponge pieces consisting of whey protein isolate in water (stained with food colorant). Water is absorbed into the sponge structure.

FIG. 5: Liquid absorption capacity (grey triangles) and fraction of filled pore volume (black squares) of the edible formulation after absorption of Milli Q water or silicon oil for a sample with a porosity of 94 vol %.

FIG. 6: Water absorption into the whey protein sponge structure after compression by hand and re-immersion in water.

FIG. 7: Compression test (texture analyser) of a water-filled and a silicon oil-filled whey protein sponge at a compression velocity of 0.02 mm/s.

FIG. 8: Whey protein isolate sponge dried at 50W/60° C. in dry state and filled with olive oil.

FIG. 9: Italian biscuit filled with dry whey protein sponge immersed in a beverage (coffee with milk). The beverage is absorbed into the spongy core.

FIG. 10: Cannelloni pasta filled with whey protein isolate sponge in boiling water to cook the pasta. The sponge filling does not disintegrate but absorbs the water, becomes juicy and softens as well.

FIG. 11: Whey protein sponge immersed in hot cranberry juice with agar (left) and jelly-filled sponge after cooling (right).

FIG. 12: Stress-strain curve of cranberry juicy jelly compared to jelly-filled sponge in penetration or compression at a velocity of 0.5 mm/s. The support of the sponge structure causes a tremendous increase in stiffness.

### DETAILED DESCRIPTION OF THE INVENTION

Definitions

The following definitions are provided for the technical features used throughout the specification.

Sponge-like denotes a porous structure with 5-95 vol % porosity and up to 100% of open pore or pore channel structure, which allows for the passive or active absorption of a liquid into the porous structure.

Juiciness denotes a sensory attribute perceived when eating e.g., fresh fruit and vegetable (water release) or meat (water and oil release), and describes the amount of liquid released during mastication, the force at which the juice is expelled, the amount of juice released at the first bite and over time, the consistency of the juice, and the contrast between liquid and solid. Thus, juiciness requires that a food product can hold a liquid and release the liquid upon compression or breaking such as during mastication.

Heat induced expansion denotes an increase of aerated product pore volume by more than 25%, preferably more than 50% upon heating and vapor pressure generation.

Protein denaturation through heating denotes unfolding or dissociation of the protein structure induced by heat, followed by re-association and/or aggregation. The transition from native to denatured state is associated with an alteration in secondary and tertiary structure of the protein through rupture of hydrogen bonds, ionic interactions and cleavage of disulfide bridges.

Volumetric heating denotes heating of an entire volume (center to surface) of a structure or product, e.g., by application of electromagnetic waves, such as microwaves, which penetrate into the structure resulting in heat dissipation. This is in contrast to heating by convection or conduction, which leads to heating of the surface and subsequent heat transfer from the surface toward the center.

Electromagnetic waves or radiation denote waves of an electromagnetic field propagating through space and carrying electromagnetic radiant energy. It includes radio waves, microwaves, infrared, visible light, ultraviolet, X-rays and gamma-rays.

The temperature gradient or relative temperature gradient denotes the temperature difference between the geometric center of the cross-section (in radial direction) and the temperature in the surface layer divided by the center temperature (Temp. gradient=(Tcenter−Tsurface)/Tcenter. It can be assessed by measuring the temperature in the geometric center and in the surface layer at maximum half the radius of the moulded or shaped foam structure by means of fiber-optic temperature sensors.

Disintegrating means breaking into more than one piece, for example after the edible formulation is filled with water or oil and then squeezed, or when the edible formulation is stored in or comes in contact with water or oil.

Protein denotes plant and/or animal based bio-macromolecules, consisting of one or more long chains of amino acid residues. A protein is typically a polymer consisting of 50 or more amino acid residues linked by peptide bonds. Proteins are digested in the stomach and intestine by hydrochloric acid and endogenous enzymes. Proteins are an essential nutrient for the human body are contained in larger amounts in meat, milk, egg, legumes, seeds, and some grains like rice or oats. Examples of proteins of the invention are whey protein, egg white protein, pea protein, and soy protein.

Fibre (or dietary fibre) denotes carbohydrate polymers with 10 or more monomeric units, which are not hydrolysed by the endogenous enzymes in the small intestine of humans. The solubility of dietary fibre is determined by the relative stability of the ordered and disordered form of the polysaccharide. Molecules that fit together in a crystalline array are likely to be energetically more stable in solid state than in solution. Hence, linear polysaccharides, i.e., cellulose, tend to be insoluble (non-soluble), while branched polysaccharides or polysaccharides with side chains, such as pectin or modified cellulose, are more soluble. Hence, non-soluble fibre denotes fibre with low or no solubility in water. This might however contain residues of soluble fibre due to the production/extraction process. Soluble fibre denotes dietary fibre with high solubility such as pectin. Examples of fibres of the invention are non-starch plant polysaccharides, such as cellulose fibre, for example citrus fibre, hemicelluloses, pectin, β-glucans, mucilages and gums.

Starch denotes a polymeric carbohydrate having a large number of glucose units joined by glycosidic bonds. Starch is a polysaccharide comprising glucose monomers joined in α1,4 linkages. The simplest form of starch is the linear polymer amylose; amylopectin is the branched form. Starch is hydrolyzed by the endogenous enzymes in the small intestine of humans. It is the most common carbohydrate in human diets and is contained in large amounts in staple foods like potatoes, wheat, maize, rice, and cassava.

Edible fats and oils are lipid materials derived from animals or plants. Physically, oils (e.g. sunflower, canola) are liquid at room temperature, and fats (e.g. lard) are solid. Chemically, both fats and oils are composed of triglycerides. They are essentially non-soluble in water.

Sugar is the generic name for sweet-tasting, soluble carbohydrates. The various types of sugar are derived from different sources. Simple sugars are called monosaccharides and include glucose (also known as dextrose), fructose, and galactose. “Table sugar” or “granulated sugar” refers to sucrose, a disaccharide of glucose and fructose. In the body, sucrose is hydrolyzed into fructose and glucose. Examples of sugars as used herein are sucrose, fructose, glucose.

Vegetarian edible formulations or vegetarian food products do not comprise any animal products, with the exception of egg products and dairy products.

When a composition is described herein in terms of wt %, this means a mixture of the ingredients on a dry basis, unless indicated otherwise.

Porosity denotes the fraction of pore volume in the entire volume of the porous edible formulation, wherein the pore volume denotes the accumulate volume of all pores.

Brittle denotes fracturing upon exceeding the elastic deformation limit without undergoing plastic deformation.

Elastically and plastically deforming or elastic-plastic deformation of porous solids denotes elastic deformation followed by plastic yielding of the structure and stands in contrast to brittle crushing of the structure. The elastic part of the deformation is typically reversible, while the plastic part is typically irreversible.

The terms “comprising”, “comprises” and “comprised of” as used herein are synonymous with “including” or “includes”; or “containing” or “contains”, and are inclusive or open-ended and do not exclude additional, non-recited members, elements or steps. The terms “comprising”, “comprises” and “comprised of” also include the term “consisting of”.

As used herein the term “about” means approximately, in the region of, roughly, or around. When the term “about” is used in conjunction with a numerical value or range, it modifies that value or range by extending the boundaries above and below the numerical value(s) set forth. In general, the term “about” is used herein to modify (a) numerical value(s) above and below the stated value(s) by 10%.

Substantially devoid, as in substantially devoid of, for example, fat or sugar means an amount which is less than 5 wt %, preferably less than 4 wt %, preferably less than 3 wt %, preferably less than 2 wt %, preferably less than 1 wt %, or even completely absent (0 wt %).

Substantially dry denotes drying to an extent that the water content is below 10 wt %.

Substantially the same velocity during absorption of oil and water denotes a relative difference in velocity of not more than 200% at same liquid viscosity, given that water and oil might not show the same wettability towards the porous edible formulation nor the same surface tension toward air.

Method of Making a Porous Edible Formulation

The formulation can be made by foaming a highly-concentrated protein dispersion followed by microwave-convection drying. Depending on the viscosity of the protein dispersion, the foaming step may be performed by extrusion foaming, membrane foaming or other foaming techniques. The resulting foam structure is optionally moulded or shaped followed by heating and optionally drying by controlled volumetric heating through superposition of electromagnetic heating, e.g., microwave, and hot air. Volumetric heating such as generated by microwave results in quick steam generation and accumulation in the foam bubbles causing expansion of the foam structure. Expansion can thus be performed by volumetric heating, for example by microwave heating. Expansion can also be performed by application of a vacuum. At the same time, heating causes fast denaturation of the proteins at the bubble interface and in the foam Iamellae. Controlled microwave power input and hot air temperature allow for a generation of a homogeneous temperature distribution throughout the structure. This leads to a homogeneous expansion, denaturation and continuous transport of moisture from the material to the surface and surrounding and thus to a late crust formation. The foam bubbles expand to an extent that they coalesce and form open channels throughout the structure. The resulting dry open-porous and stiff structure adsorbs water and/or oil to comparable extents given by the accessibility of both hydrophilic and hydrophobic parts of the intrinsically amphiphilic proteins. Other heating methods can be used, which allow for volumetric heating, such as infrared heating and Ohmic heating.

Porous Edible Formulation

The edible dry foam sponge material of the invention, upon contact with a liquid phase (aqueous or oil phase), can take up the liquid and release it again upon applying a stress or upon suction to it as done during mastication. The release of liquid generates the juicy perception during mastication without playing on the crunchiness of the material. The dried foam, denoted also as dry sponge, is made out of globular proteins that denature upon heat treatment, such as whey protein isolate. Other globular proteins can also be used. The dry sponge adsorbs the liquid without disintegrating the sponge structure and may thus be applied as a dried foamed material that is able to take up and release a liquid to give a juicy perception.

The sponge material can absorb both aqueous and oily phases. The sponge texture can be modulated by adding additional fibres.

Food Product

The juicy material can be applied in food products to incorporate juiciness or deliver liquid upon mastication. This includes filling of biscuits, breakfast cereals or snack products, which can be soaked in a liquid (e.g., milk, coffee, juice, water) prior to consumption. It can be filled with high-viscous liquids or jellifying liquids in order to create a jelly structure with higher mechanical stability, such as fruit- or vegetable-like pieces for application in yoghurt, drinks or soups, and may contain natural or added amounts of functional food components like micronutrients. The juicy material can be combined with crunchy materials. The sponge structure can be applied as instant product, which softens upon contact with water, such as an instant noodle, instant filling of pasta, snacks, dumplings, or pet food.

### EXAMPLES

### Example 1

### Whey Protein Sponge Production and Comparison to Pure Hot Air Drying

About 40 wt % whey protein isolate was dispersed in tap water and hydrated overnight. The dispersion was foamed by dispersing nitrogen in the protein dispersion with a rotating membrane foaming device. The resulting protein foam had a gas volume fraction of 70 vol % and a number weighted mean bubble size d50.0=54 um with a bubble size distribution width defined by the SPAN (=(x90.0−x10.0)/x50.0) of 1.28.

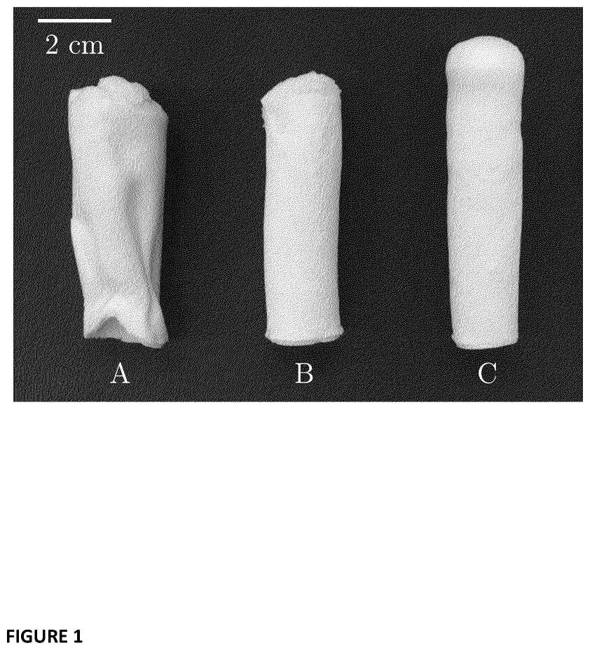

About 24 mL of the foam was filled into cylindrical transparent polypropylene moulds with a diameter of 27.5 mm and a height of 86 mm. The samples (4 samples per trial) were dried at a microwave power of 100 W and a hot air temperature of 60° C. for over 2 hours or at a microwave power of 50 W and a hot air temperature of 60° C. over 3 hours. The resulting dry foam with a diameter of 20 mm and a height of 70-85 mm, shown in FIG. 1 (B) and (C), can be removed from the mould and further processed, for example by cutting into pieces. For comparison, FIG. 1 (A) shows the same foam dried without superposition of microwave only with hot air (convection) at a temperature of 100° C. over 3 hours. It has a heterogeneous, wrinkled, partly shrunken structure with a darker outer crust

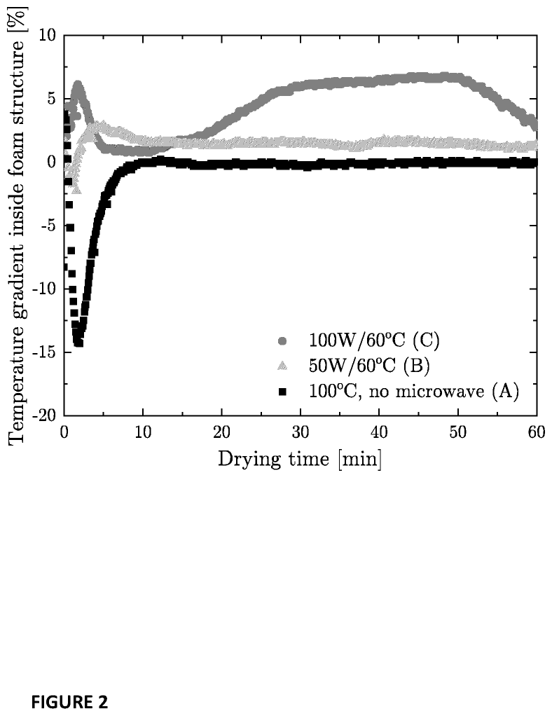

Measuring the temperature of the foam structure during heating and drying in the radial center and in the surface layer, showed the importance of a homogeneous relative temperature gradient during the heating and drying process. FIG. 2 shows the relative temperature gradient over the cross section of the cylindrical foam product, defined as temperature difference between geometric radial center and surface layer divided by the center temperature [=(Tcenter−Tsurface)/Tcenter]. Pure hot air drying leads to a highly negative relative temperature gradient, meaning that the surface heats up much faster than the center. In contrast, superposition of microwave caused a slightly faster heating of the core or an even heating throughout the foam structure. This results in an even expansion, protein denaturation and water transport during drying and thus minimises evaporation-induced uneven shrinkage and allows for the generation of a homogeneous porous structure.

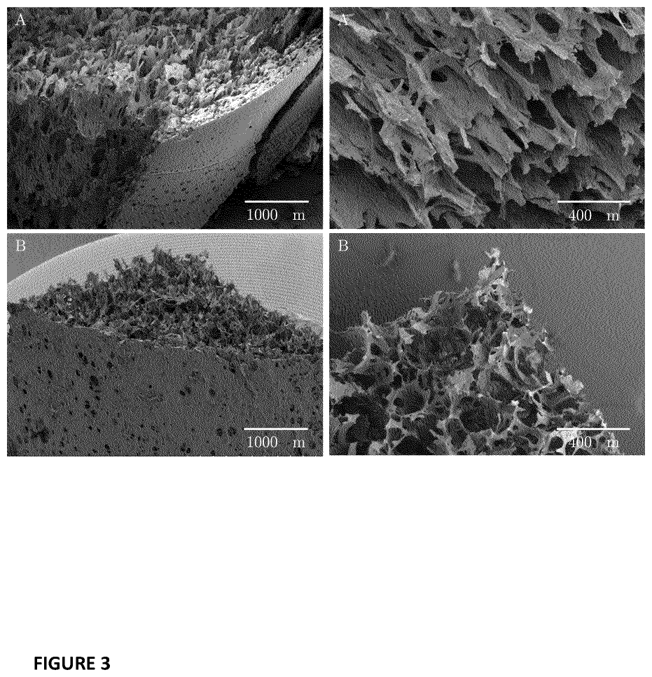

Scanning electron microscopy images of the same samples (A) and (B) shown in FIG. 3 reveals a denser crust and a sheet-like structure when drying with hot air (convection) only (A) and an open-porous surface and pore structure with spherical pores when drying with microwave and hot air (B). The spherical pores are foam bubbles retained throughout the heating and drying process.

### Example 2

### Sponge-like Liquid Absorption of Edible Formulation

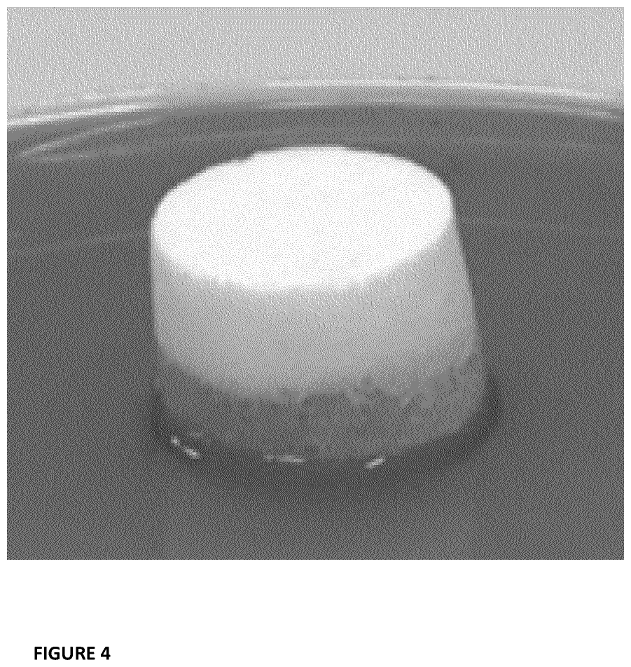

A sponge piece of 20 mm height of sample (C) (100 W/60° C.) in Example 1, with a density of 0.09 g/cm³, shown in FIG. 4 in water (stained with food colorant), absorbed 15 g water ((η=1 mPas; ρ=1.0 g/cm³) and 9 g low-viscous silicon oil (η=3 mPas; ρ=0.9 g/cm³) per g sample at a velocity of approximately 2.2 mm/s for water and approximately 1.5 mm/s for oil.

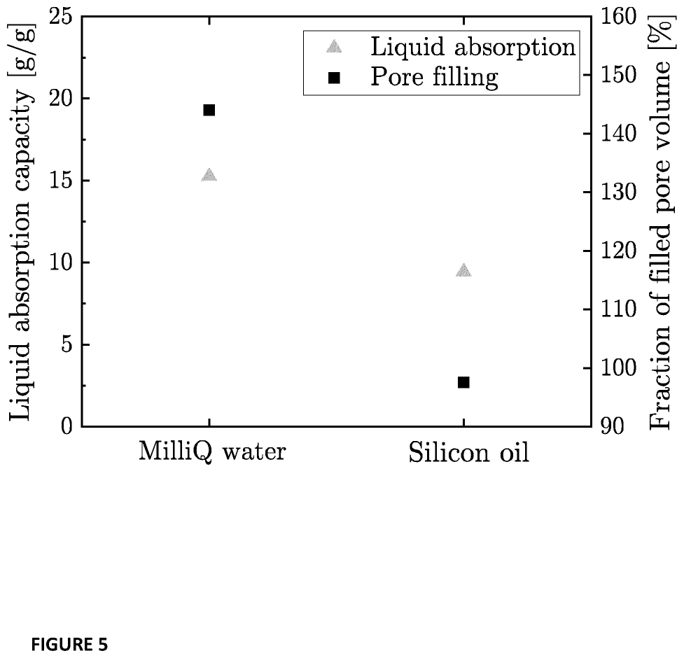

Assuming a solid density of whey protein isolate of 1.4 g/cm³, the density of the dry porous structure of 0.09 g/cm³ corresponds to a porosity of 94 vol %. Hence, at the measured oil absorption capacity, 94% of the pore volume in the dry porous structure must get filled with oil. In contrast, the water filled up over 140% of the pore volume (see FIG. 5), meaning that the edible formulation swells upon absorption of water.

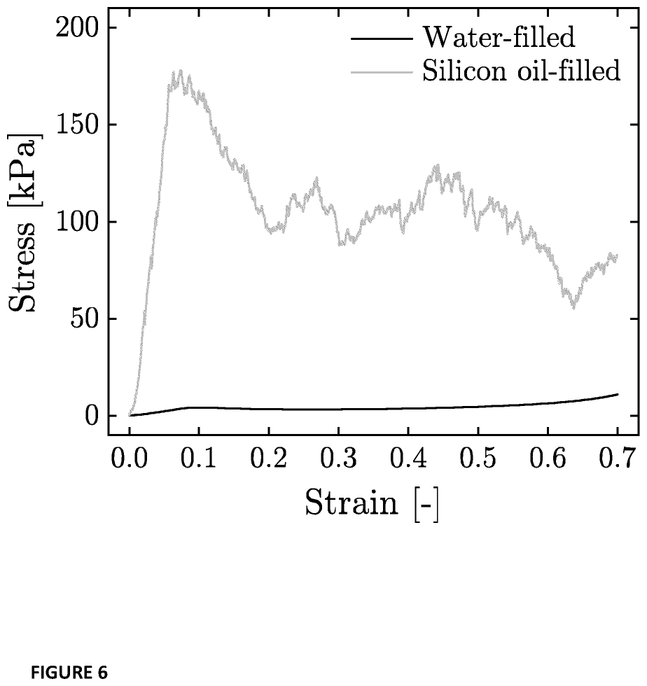

Absorption of water into the whey protein sponge structure causes softening, whereas the sponge remains brittle and stiff upon absorption of oil. FIG. 6 shows the mechanical properties in compression of a water-filled and an oil-filled whey protein sponge at a compression velocity of 0.02 mm/s.

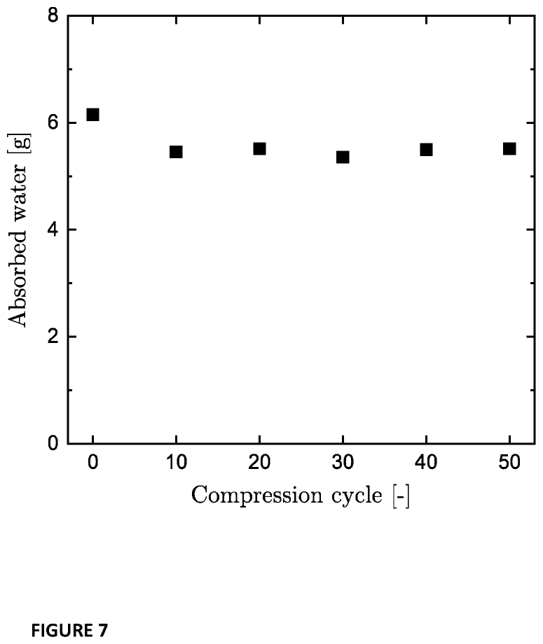

As the sponge softens upon absorption of water, the water can be pressed out, e.g., by hand, and the sponge can be refilled. The weight of absorbed water decreased by not more than 15% over 50 compression and re-absorption cycles, as shown in FIG. 7.

A sponge filled with oil cannot be compressed and re-filled due to the brittle structure. The oil could however be removed by suction, e.g., by vacuum. Alternatively, the sponge can be softened by absorption of water, subsequently the water is squeezed out and the sponge is immersed in oil and absorbs the oil. Thus, the sponge structure is soft and elastic and the absorbed oil can be squeezed out by hand.

### Example 3

### Oil Absorption of Whey Protein Sponge

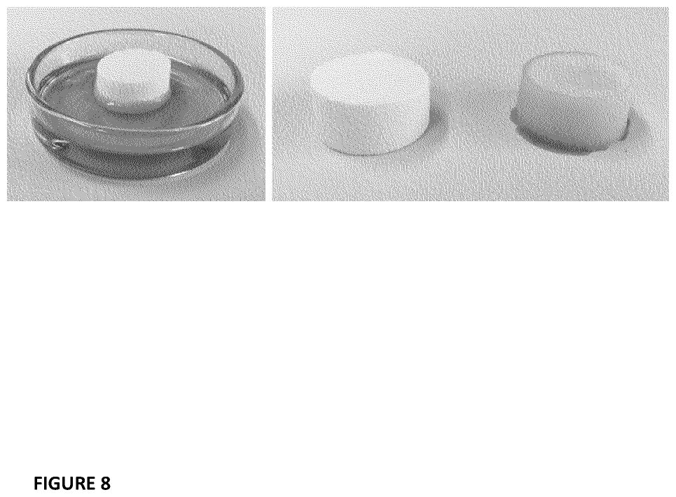

A foam was produced and moulded as described in Example 1. The foam was dried at 50 W microwave and 60° C. hot air over 3 h, unmoulded and cut into pieces. The resulting sponge was soaked in olive oil as shown in FIG. 8. It instantly absorbed the liquid and stayed stiff and brittle.

### Example 4

### Whey Protein and Egg White Protein Sponge in Biscuit

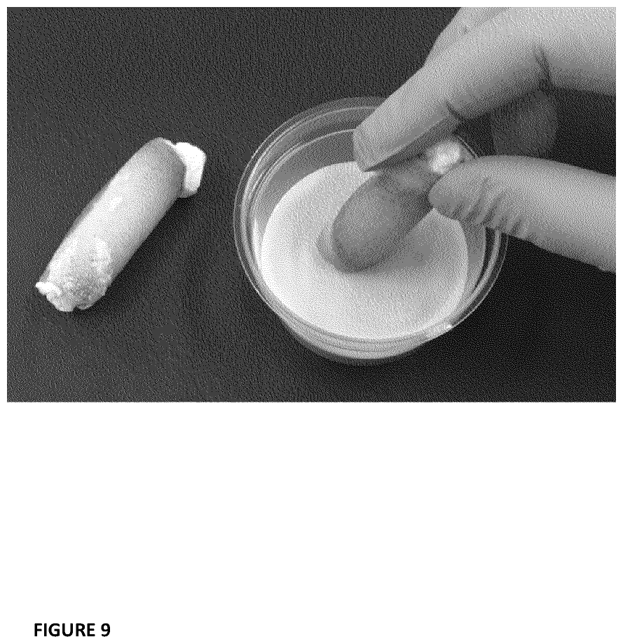

A foam was produced as described in Example 1. Whey protein foam was filled into commercial Italian biscuits (“cannoli”) and dried in an oven at 100 W and 60° C. over 20 min. The finished product can be immersed in a beverage, e.g., juice, coffee, milk, as shown in FIG. 9. The sponge material in the core absorbs the liquid while the outer part stays crunchy. The same procedure can be applied to egg white protein foam at same solid concentration and gas volume fraction.

### Example 5

### Whey Protein Sponge in Pasta

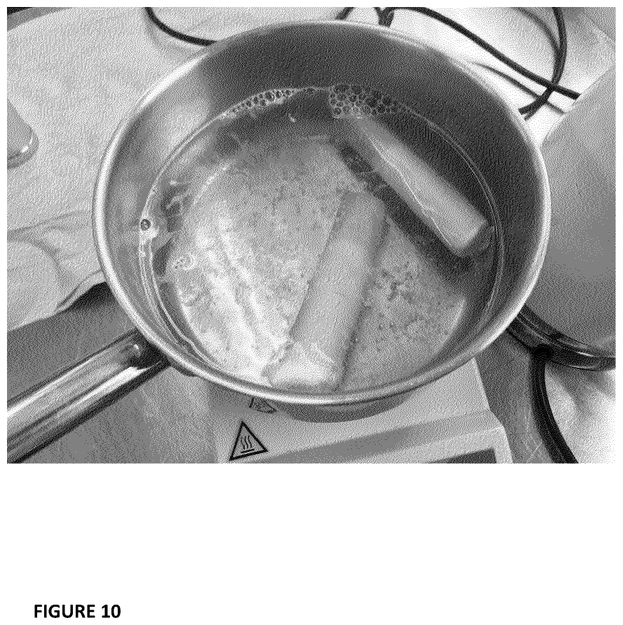

A foam was produced as described in Example 1. Whey protein foam was filled into commercial dry cannelloni pasta and dried in an oven at 100 W and 60° C. for 1.5 hours. The cannelloni with dry protein filling may be cooked in boiling water to soften the pasta (see FIG. 10). The filling does not dissolve or disintegrate but absorbs water resulting in al dente cannelloni with a juicy protein filling.

### Example 6

### Production of Soy Protein Sponge

About 18 wt % soy protein isolate was dispersed in tap water and hydrated overnight; foamed with a kitchen machine (Kitchen Aid) to reach a gas volume fraction of approximately 20 vol %; the foam was distributed onto a Teflon plate in portions of 2 table spoons and dried at 50 W and 60° C. over 1 hours. The resulting stiff sponge structure absorbed water without disintegrating and softened when filled with water.

### Example 7

### Soy Protein Sponge as Instant Noodles

The soy protein foam described in Example 6 is shaped into thin strands of 3-5 mm in diameter with an icing bag and dried at 50 W/60° C. over 30 min with an additional water bath placed in the oven below the tray. The resulting dry porous noodle-like product can be soaked in water, absorbs the water and softens instantly without application of heat. It is solely composed of soy proteins.

### Example 8

### Production of Pea Protein Sponge

About 18 wt % pea protein isolate was dispersed in tap water and hydrated overnight; foamed with a kitchen machine (Kitchen Aid) to reach a gas volume fraction of approximately 20 vol %; the foam was distributed onto a Teflon plate in portions of 2 table spoons and dried at 50 W and 60° C. over 1 hours. The resulting stiff and crunchy sponge structure slowly absorbed water without disintegrating and softened when filled with water. When immersing in oil, it slowly absorbed the oil and kept its crunchiness. Pieces of this pea protein sponge could be further processed, e.g., cut, into protein-based croutons.

### Example 9

### Whey Protein Sponge Reinforced with Citrus Fibres

About 40 wt % whey protein isolate and 5 wt % citrus fibres were dispersed in tap water and hydrated overnight. The dispersion was foamed in a kitchen machine (Kitchen Aid) to reach a gas volume fraction of 40 vol %. Approximately 24 mL of the foam was filled into cylindrical transparent polypropylene moulds with a diameter of 27.5 mm and a height of 86 mm. The samples were dried at a microwave power of 100 W and a hot air temperature of 60° C. over 2 hours. The resulting dry sponge absorbs both water and oil and is stiffer and stronger compared to the pure whey protein sponge.

### Example 10

### Whey Protein Sponge Filled with Jellified Fruit Juice

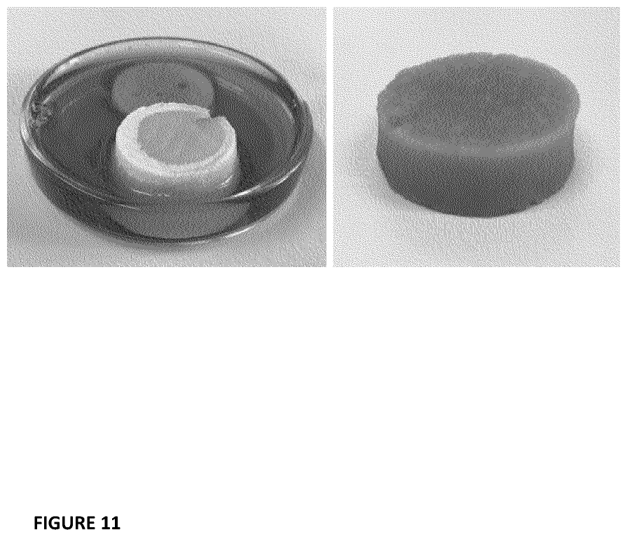

200 mL cranberry juice were mixed with 0.7 g agar agar powder, heated to boiling for 1 min. Whey protein sponge produced as described in Example 2 was soaked in the hot cranberry juice-agar agar mixture. The juice was immediately absorbed into the sponge structure (FIG. 11). The filled sponge was cooled for 4h at 4° C. to cause gelation of the cranberry juice-agar agar mixture.

For comparison, cranberry juice jelly was produced with the same concentration of agar agar powder by moulding into a plastic beaker and cooling. The cranberry juice jelly was not self-sustaining without mould.

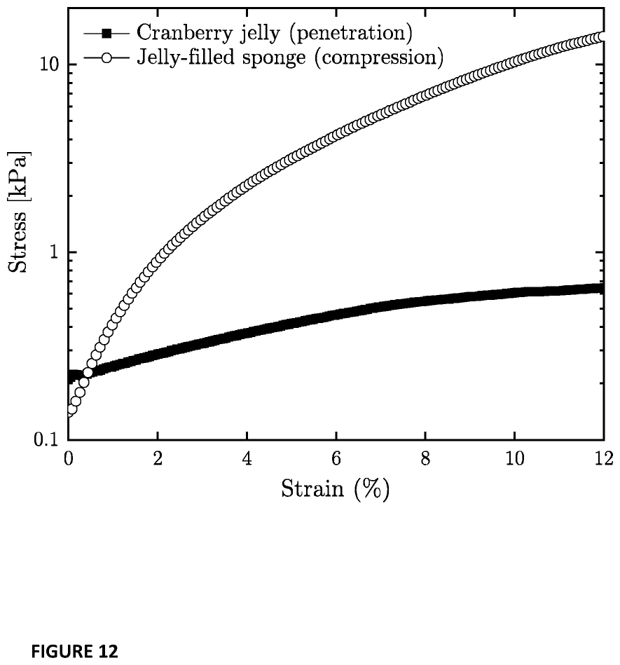

The stiffness of the jelly-filled sponge and the pure jelly was compared by texture analysis by compression and penetration, respectively, as shown in FIG. 12 at a velocity of 0.5 mm/s. Although the sponge structure makes up below 10 wt % of the jelly-filled sponge (>90 wt % cranberry juice jelly), the Young's modulus, a measure of stiffness, increases from approximately 35 Pa to 1500 Pa compared to the pure jelly. The Young's modulus was determined as slope in the linear regime at a strain of 6-8%. The initial part of the stress-strain curve (strain=0-5%) shows tailing due to the slightly uneven surface of the sample. The jelly-filled sponge has a texture comparable to a fruit piece. By adapting the degree of gelation inside of the sponge, the extent of juiciness can be adjusted.

### Example 11

### Production of Sponge Particles without Mould

40 wt % whey protein isolate was dispersed in tap water and hydrated overnight. Foaming with a kitchen whipping machine (Kitchen Aid) resulted in a gas volume fraction of approximately 65 vol %. Drops of 5-10 mm diameter of the foam were deposited onto a Teflon plate and dried at 150 W and 60° C. for 30 minutes with an additional beaker inside the oven cavity filled with 500 mL water for higher humidity. The resulting stiff sponge piece absorbed water without disintegrating and softened when filled with water. When in contact with oil, the sponge structures absorbed the oil without disintegrating but remained brittle.

### Example 12

### Production of Sponge Spheres in Moulds

The foam was prepared as described in Example 11. The foam was transferred into praline moulds with a diameter of about 15-30 mm and dried at 150 W and 60° C. for 30 minutes with an additional beaker inside the oven cavity filled with 500 mL water for higher humidity. The resulting stiff sponge structure spheres absorbed water without disintegrating and softened when filled with water. When in contact with oil, the sponge structures absorbed the oil without disintegrating but remained brittle as described in Example 2.

### Example 13

### Production of Sponge without Post-drying

The foam was prepared as described in Example 11. The foam was transferred into cylinders as in Example 1 and dried at 100 W and 60° C. for 15 minutes. The resulting porous formulation had a moisture content of approximately 50% and absorbed water and oil without disintegrating. The liquid absorption capacity for water was approximately 6 g/g sample and for oil 3 g/g sample.

1. A method of making a porous edible formulation that can absorb water and oil, said method comprising the steps:
Preparing a 5-60 wt % protein dispersion in aqueous liquid, preferably in water;
Dispersing gas in the protein dispersion to form a foam structure;
Expansion of the foam structure; and
Volumetric heating induced water evaporation and protein denaturation;
wherein volumetric heating and/or drying comprises the application of electromagnetic waves.

2. The method according to claim 1, wherein 10-50 wt % protein dispersion is prepared in aqueous liquid.

3. The method according to claim 1, wherein gas is dispersed in the protein dispersion using a mechanical device to form a foam structure, wherein the mechanical device is a rotating membrane foaming device to form a foam structure.

4. The method according to claim 1, wherein said wet foam structure has a gas volume fraction of 10-90 vol %.

5. The method according to claim 1, wherein the electromagnetic waves are applied by microwave heating, most preferably microwave heating with superposition of convection heating.

6. The method according to claim 1, wherein the relative temperature gradient between the core and the surface layer of the foam structure is between −0.1 and 0.3, and the average foam structure temperature is above the denaturation temperature of the protein during heating.

7. The method according to claim 1, wherein a vacuum is applied before and/or during drying which is between 100-300 mbar.

8. The method according to claim 1, wherein said edible formulation has open pores having an average pore size diameter of up to 500 microns.

9. A porous edible formulation comprising protein, obtained by a method according to claim 1.

10. A porous edible formulation that can absorb water and oil and comprises protein, wherein the edible formulation has a water content <10 wt % and has a porosity of between 10-95 vol %, and wherein said formulation can absorb water and oil without disintegrating and/or dissolving to an extent of no greater than 10 wt %.

11. The porous edible formulation according to claim 10, wherein said formulation further comprises citrus fibre and/or polysaccharides.

12. The porous edible formulation according to claim 10, wherein said formulation is capable of absorbing water and oil at substantially the same velocity, preferably up to 5 mm/s, and wherein the absorbed water and oil can be removed by compression or suction and re-absorbed into the same edible formulation.

13. The porous edible formulation according to claim 10, wherein said formulation is capable of absorbing water with a temperature of 0-100° C. to an extent that up to 140%, of pore volume is filled with water due to additional structural swelling effects.

14. The porous edible formulation according to claim 10, wherein said formulation is capable of absorbing oil with a temperature of 0-200° C. to an extent that up to 90% of pore volume, preferably up to 95% of pore volume is filled with oil.

15. The porous edible formulation according to claim 10, wherein said formulation is elastically and/or plastically deformable after absorption of water and is brittle in substantially dry state and after absorption of oil.

16. The porous edible formulation according to claim 10, wherein said edible formulation is fat free.

17-18. (canceled)
